(19) United States
(12) Patent Application Publication
(10) Pub. No.: US 2005/0108110 A1
(43) Pub. Date: May 19, 2005

(54) System operative over the world wide web for offering, to potential purchasers at web receiving stations, computer systems optimized to the purchaser's needs based upon prompted purchaser entries defining sets of attribute values at component and overall system levels

(75) Inventors: Timothy Alan Dietz, Austin, TX (US); Walid M. Kobrosly, Round Rock, TX (US); Nadeem Malik, Austin, TX (US)

Correspondence Address: Mark S. Walker;International Business Machines Corporation, Intellectual Property Law Department, Internal Zip 4054, 11400 Burnet Road, Austin, TX, 78758, US

(73) Assignee: International Business Machines Corporation, Armonk, NY (US)

(21) Appl. No.: 10/713,962

(22) Filed: Nov. 13, 2003

(51) Int. Cl. G06F 17/60

(52) U.S. Cl. 705/27

(57) ABSTRACT

Accessing the individual components of a planned product via Web searching that provides a product optimized to the purchaser's, i.e. the developer or builder's needs. Prompting a purchaser, e.g. a developer of a computer system, to make a sequence of a plurality of interactive data entries at a Web display station defining the values of a respective set of attributes selected by the purchaser for each of the components in the planned system, together with searching on the Web for sources of components having attributes satisfying purchaser defined values. Then prompting the purchaser to make a sequence of interactive data entries defining the values of a set of attributes selected by said purchaser that would be applicable for the overall computer system in combination with means for determining a computer system optimized to purchaser selected values of the attributes of each of said components from said Web sources, but reconciled with the attribute values selected by the purchaser for the overall computer system. Thus, the search for the optimum individual components must continuously be reconciled to determine whether such components come within the overall computer system umbrella defined by user or purchaser input.

### TECHNICAL FIELD

The present invention relates to searching in the World Wide Web (Web), and particularly to electronic business applications of such Web searching involving the locating of components to be used in the development of commercially and technically optimized products.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web. The convergence of the electronic entertainment and consumer industries with data processing exponentially accelerated the demand for wide ranging communication distribution channels, and the Web or Internet, which had quietly existed for over a generation as a loose academic and government data distribution facility, reached “critical mass” and commenced a period of phenomenal expansion. With this expansion, businesses and consumers have direct access to all matter of databases providing documents, media and computer programs through related distribution of Web documents, e.g. Web pages or electronic mail. Because of the ease with which documents are distributable via the Web, it has become a major source of data. Virtually all databases of public information throughout the world are accessible and able to be searched via the Web.

The ease with which great volumes of data may be searched from a computer attached to the Internet and equipped with a Web browser has led to the development of widespread electronic commerce over the Web. At the present time, it is becoming very rare to find a business organization of any kind that does not transact some aspect of the business via the Web. As consumers and businesses become more familiar and comfortable with Web transactions, they become more and more willing to try the Web for other commerce. One business area that has received a great deal of attention in recent years are Web search services that promise the consumer or business the finding of products having the lowest possible price. To a great extent, such services have been disappointing to the consumer and business public because such users have very often found that there were considerably more disadvantages involved with located products than just price. To this end, recent providers of lowest price search services have enabled the consumer to request the lowest price for a product subject to some consumer entered or imposed limitations, e.g. on airline tickets: “direct flights only” limitations. While such allowance may offer advantages in searches for lowest price in relatively simple purchases, there is little help for the business purchaser seeking to optimize the more complex development of items of manufacture. In such developments, there are a whole complex of limitations or licenses that must be considered for the components and the resulting whole products, e.g. laws, industry standards, qualification of proposed suppliers, environmental effects etc.

### SUMMARY OF THE PRESENT INVENTION

The present invention provides an implementation for accessing the individual components of a planned product via Web searching that provides a product optimized to the purchasers, i.e. the developer or builder's needs. The invention is directed toward solution for the builder of a computer system including developers, as well as individual users who are trying to build their own computers with leading edge but reliable and accepted components.

In its broadest aspect, the invention involves means for prompting a purchaser, e.g. a developer of a computer system, to make a sequence of a plurality of interactive data entries at a Web display station defining the values of a respective set of attributes selected by the purchaser for each of the components in the planned system, together with means for searching on the Web for sources of components having attributes satisfying purchaser defined values. In addition, the invention also provides means for prompting the purchaser to make a sequence of interactive data entries defining the values of a set of attributes selected by said purchaser that would be applicable for the overall computer system in combination with means for determining a computer system optimized to purchaser selected values of the attributes of each of the components from the Web sources but reconciled with the attribute values selected by the purchaser for the overall computer system. Thus, the search for the optimum individual components must continuously be reconciled to determine whether such components come within the overall computer system umbrella defined by the user or purchaser input. The resulting optimized computer system is then offered to the potential purchaser via his Web display station.

The implementation of the invention is particularly advantageous to the developer who is seeking components in quantities to satisfy manufactured product market estimates or demands. Such a developer is, of course, subject to all of the industry standards, legal limitations and the environment. All such factors may be entered into the overall optimized computer product system umbrella so that proposed components found in the search may be reconciled with the limitations of the overall product.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the receiving display station through which the optimum components may be searched for in accordance with the present invention;

FIG. 2 is a generalized diagrammatic view of a Web portion upon which the present invention may be implemented;

FIG. 3 is an illustrative display panel on a Web display station showing how the purchaser may be prompted to make entries defining selected attributes of the components of importance to the user, as well as the defined range of values of the attributes;

FIG. 4 is an illustrative display panel on a Web display station showing how the purchaser may be prompted to make entries defining selected attributes of the overall offered computer system of importance to the user, as well as the defined range of values of the attributes;

FIG. 5 is an illustrative display panel like that of FIG. 4 but containing an alert notice to the purchaser that his selected attributes for the overall system or the components have produced a conflict;

FIG. 6 is an illustrative flowchart describing the setting up of the process of the present invention through which the Web searches are carried out for defining and offering an optimized computer system to a purchaser on the Web; and

FIG. 7 is a flowchart of an illustrative run of the process set up in FIG. 6.

### DETAILED DESCRIPTION OF THE PREFERRED EMBODIMENT

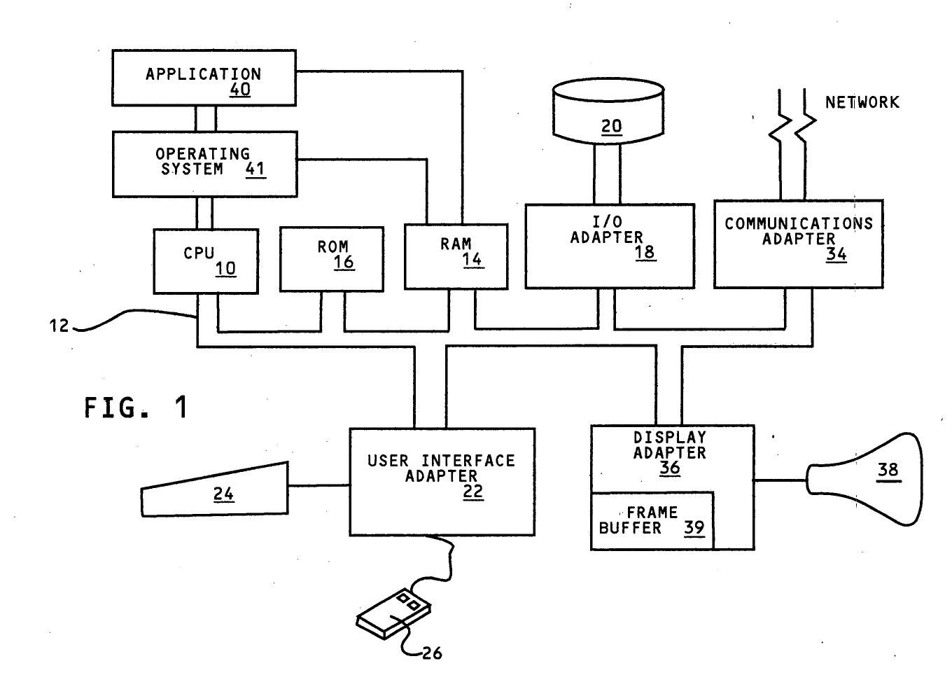

Referring to FIG. 1, a typical data processing terminal is shown that may function as the Web display stations used for prompting for purchaser entries selecting system and component attributes and values, and for conducting the Web searches for defining and offering an optimized computer system to a purchaser on the Web. The data processing system shown may also function as the Web access server for distributing and coordinating the necessary Web searches.

A central processing unit (CPU) 10, such as one of the PC microprocessors or workstations, e.g. RISC System/6000™ (RS/6000) series available from International Business Machines Corporation (IBM), is provided and interconnected to various other components by system bus 12. An operating system 41 runs on CPU 10, provides control and is used to coordinate the function of the various components of FIG. 1. Operating system 41 may be one of the commercially available operating systems such as the AIX operating system available from IBM; Microsoft's WindowsMe™ or Windows 2000™, as well as various other UNIX and Linux operating systems. Application programs 40, controlled by the system, are moved into and out of the main memory Random Access Memory (RAM) 14. These programs include the programs of the present invention for prompting for purchaser entries, selecting system and component attributes and values and for conducting the Web searches for defining and offering an optimized computer system to a purchaser on the Web. The search programs are carried on servers that the Web display station is communicating with via the Internet. Any conventional Web browser, such as the Netscape Navigator™ or Microsoft's Internet Explorer™, as will hereinafter be described, may be used on the Web display station. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with an outside network enabling the data processing system to communicate with other such systems over a Local Area Network (LAN) or a Wide Area Network (WAN), which includes, of course, the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to Web pages that prompt the user. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Since the major aspect of the present invention is directed to Web pages transmitted over global networks, such as the Web or Internet, an understanding of networks and their operating principles would be helpful. We will not go into great detail in describing the networks to which the present invention is applicable. For details on Web nodes, objects and links, reference is made to the text, Mastering the Internet, G. H. Cady et al., published by Sybex Inc., Alameda, Calif., 1996; or the text, Internet: The Complete Reference, Millennium Edition, Margaret Young et al., Osborne/McGraw-Hill, Berkeley, Calif., 1999. Any data communication system that interconnects or links computer controlled systems with various sites defines a communications network. Of course, the Internet or Web is a global network of a heterogeneous mix of computer technologies and operating systems. Higher level objects are linked to the lower level objects in the hierarchy through a variety of network server computers.

Web documents are conventionally implemented in HyperText Markup Language (HTML) language, which is described in detail in the text entitled Just Java, van der Linden, 1997, SunSoft Press, particularly at Chapter 7, pp. 249-268, dealing with the handling of Web pages; and also in the above-referenced Mastering the Internet, particularly pp. 637-642, on HTML in the formation of Web pages.

In addition, aspects of this invention will involve Web browsers. A general and comprehensive description of browsers may be found in the above-mentioned Mastering the Internet text at pp. 291-313. More detailed browser descriptions may be found in the above-mentioned Internet: The Complete Reference. Millennium Edition particularly in Chapter 19, pp. 419-454, on the Netscape Navigator; in Chapter 20, pp. 455-494, on the Microsoft Internet Explorer; and in Chapter 21, pp. 495-512, covering Lynx, Opera and other browsers.

The invention involves the use of search engines for searching. As described in the above-mentioned Internet: The Complete Reference, Millennium Edition, pp. 395 and 522-535, search engines use keywords and phrases to query the Web for desired subject matter. Some significant search engines are: AltaVista, Infoseek, Lycos, Magellan, Webcrawler and Yahoo. Usually, the keywords are combined with some of the basic Boolean operators, i.e. AND, OR and NOT, in designing Web queries. Each search engine has its own well developed syntax or rules for combining such Boolean operators with the keywords to conduct the searches. The search engine usually uses a search agent called a “spider” that looks for information on Web pages. Such information is indexed and stored in vast databases. In carrying out its search, the search engine looks through the database for matches to keywords subject to the engine syntax. In the present invention, the search engine will search databases at Web sites maintained by computer component distributors, as well as computer industry hosted Web sites that make information, including price, available to the purchasing public. As will be hereinafter described in greater detail, the search results, as defined and limited by the data entered by the proposed purchaser, are presented to the proposed purchaser.

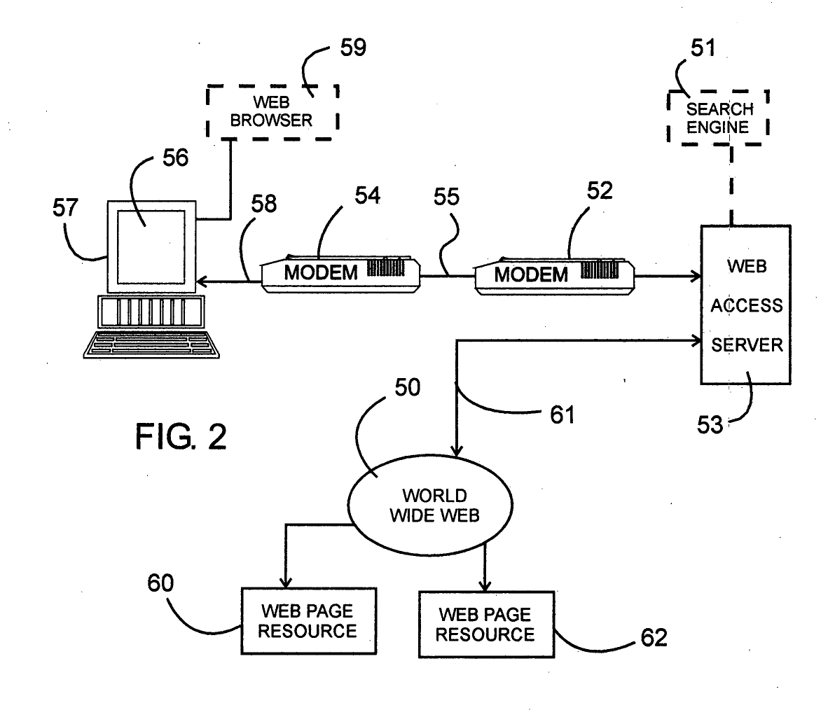

A generalized diagram of a portion of the Web in which the computer controlled display terminal 57 used for Web page receiving during searching or browsing is connected as shown in FIG. 2. Computer display terminal 57 may be implemented by the computer system set up in FIG. 1 and connection 58 (FIG. 2) is the network connection shown in FIG. 1. For purposes of the present embodiment, computer 57 serves as the receiving Web display station that will access Web documents, e.g. pages that are displayed 56. Reference may be made to the above-mentioned Mastering the Internet, pp. 136-147, for typical connections between local display stations to the Web via network servers; any of which may be used to implement the system on which this invention is used. The system embodiment of FIG. 2 has a host-dial connection. Such host-dial connections have been in use for over 30 years through network access servers 53 that are linked 61 to the Web 60. The Web servers 53 that also may have the computer structure described with respect to FIG. 1, may be maintained by a Web Service Provider to the client's display terminal 57. Such Web or Internet Service Providers (ISPs) are generally described in the above-mentioned text, Internet: The Complete Reference, Millennium Edition at pp. 14-18. The Web server 53 is accessed by the client receiving terminal 57 through a normal dial-up telephone linkage 58 via modem 54, telephone line 55 and modem 52. Any conventional digital or analog linkages, including wireless connections, are also usable. The previously described search engines 51, contacted conventionally via Web access servers, search the Web and send the selected Web documents back to the receiving display station 57 on which they may be conventionally displayed in real-time. As will be hereinafter described in greater detail, many of the functions of a receiving display station 57 with respect to the Web may be carried out by a Web browser program 59 associated with the station. Accordingly, the functions of the present invention of prompting for data entries relative to component attributes and overall system attributes and for coordination of the search results to provide the optimum computer system offered to purchaser at station 57 may be carried out by web browser 59 in combination with Web server 53. In the search, the Web pages providing data may be accessed from the Web database sources, such as sources 61 and 62, via Web 50.

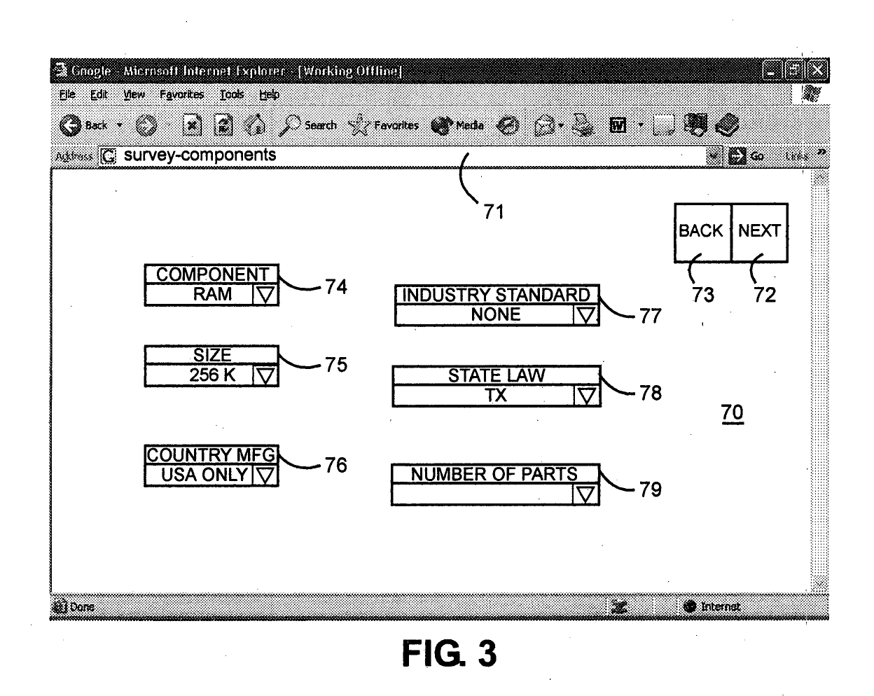

Now with respect to FIGS. 3 through 5, there will be provided an illustrative example of how the present invention may be used to prompt a potential purchaser at a receiving display station for data entries defining components and the overall computer system to be built, and for offering the price defined overall computer system to the purchaser. FIG. 3 illustrates the display panel 70 presented to a purchaser at a receiving display station to prompt the entry of component 71 attributes. The following attributes and values for a component are being solicited.

For example, the value of component scroll menu 74 is RAM; the value of size attribute scroll menu 75 is 256K; the value of country of manufacture only attribute scroll menu 76 is USA; the value of industry standard attribute scroll menu 77 is none (which indicates that no industry standards are to be applied); the value of state law attribute scroll menu 78 is TX (which indicates that the Laws of Texas are to be applied to any contract of sale to purchaser); and there is a scroll menu 79 on which the number of parts of the RAM component are being purchased is the value. The display also includes a pair of display buttons that may be clicked via mouse pointer for going back 73 or next 72 to sequential display panels. In this illustration, the next display panel is for soliciting the purchaser's requirements for the overall computer system that, in the present illustration, is a 13 inch display laptop computer 64. The following attributes for the overall system are solicited: an applicable set of state law attribute scroll menu 65 on which the laws to be applied are environmental laws; the maximum system weight attribute scroll menu 66 on which the selected value is 6.5 lbs.; the system power supply attribute scroll menu 67 on which the selected value is GE1065A supply; and the total cost attribute scroll menu 68 on which a cost value has not been selected.

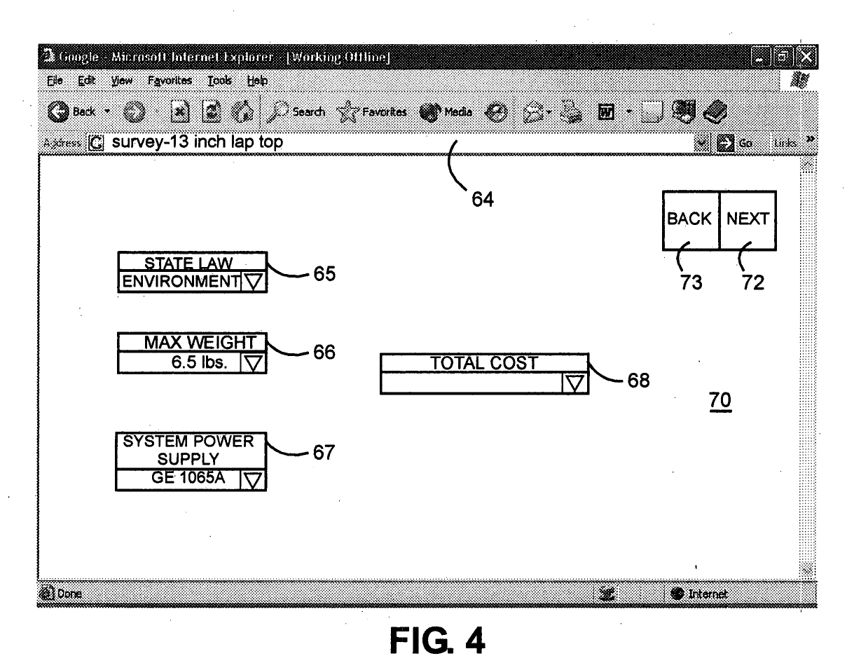

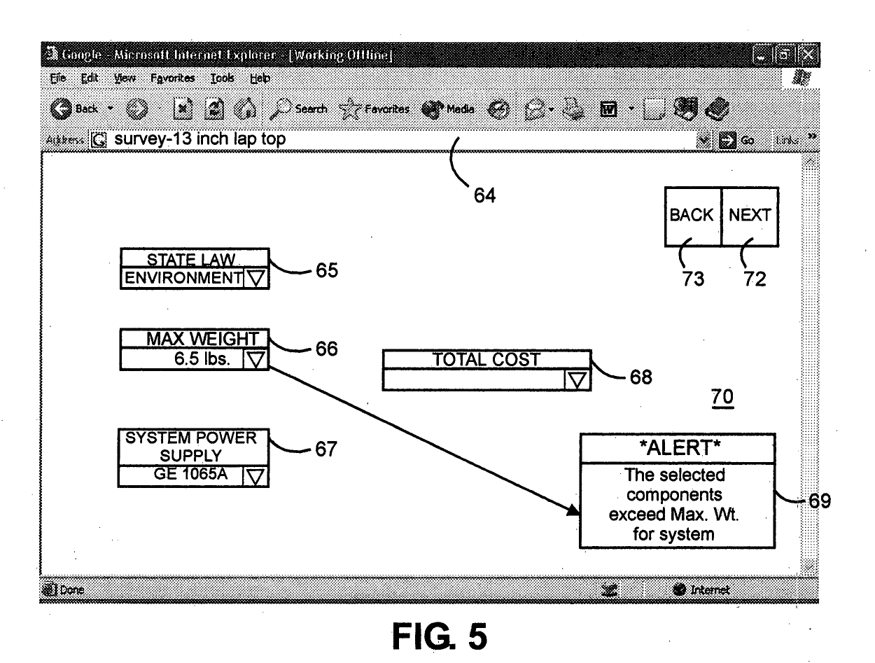

FIG. 5 is an illustration like that of FIG. 4 set up to illustrate the alert to the purchaser at the display terminal that there has been a conflict between the overall system attribute value selections entered in FIG. 4 with the individual component attribute value entries of FIG. 3. The components selected in FIG. 3 have resulted in a weight for the computer product that exceeds the system weight value entered for the maximum weight attribute 66 value, FIG. 4. The user is prompted with display alert 69. The purchaser must then change either component attribute or overall system attribute values to reconcile this illustrative difference.

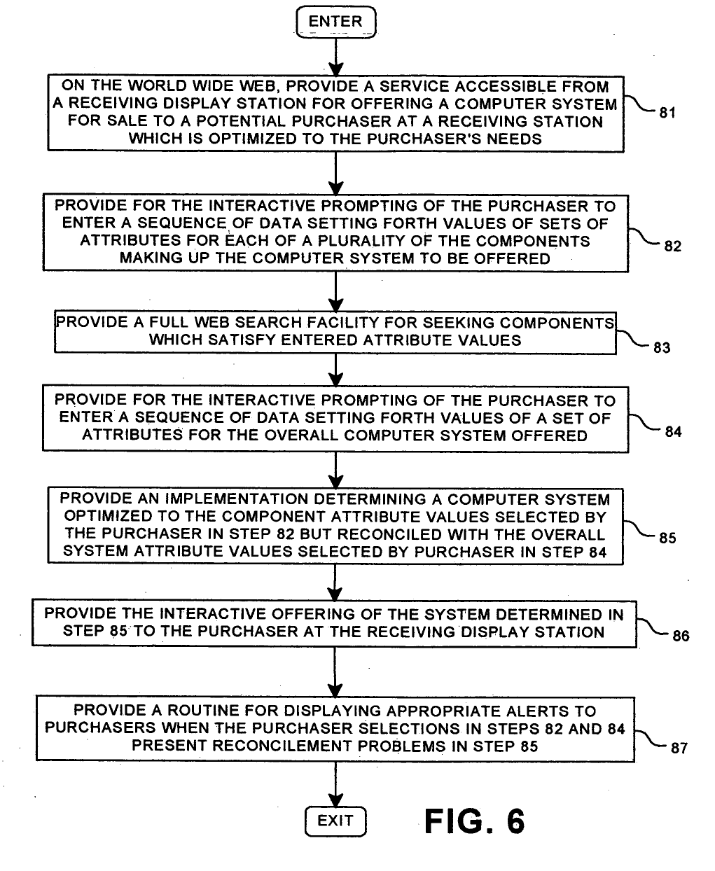

FIG. 6 is a flowchart showing the development of a process according to the present invention for prompting a potential purchaser at a receiving display station for data entries defining components and the overall computer system to be built, and for offering the price defined overall computer system to the purchaser. Most of the programming functions in the process of FIG. 6 have already been described in general with respect to FIGS. 3 through 5. On the Web, a service is provided that is accessible from a receiving display station through its Web browser in coordination with the Web access server system supporting the display station, for offering a computer system for sale to a potential purchaser at the display station optimized to the purchaser's needs, step 81. The process provides for the prompting of the purchaser to enter a sequence of data setting forth values of sets of attributes for each of a plurality of the components making up the computer system to be offered to the purchaser, step 82. The full Web search facilities are made available for seeking the combination of components to satisfy the purchaser's entered values, step 83. The process also provides for the prompting of the purchaser to enter a sequence of data setting forth values of sets of attributes for the overall computer system to be offered to the purchaser, step 84. Based upon the entries and the search results, an implementation is provided, step 85, for determining a computer system optimized to the component attribute values entered by the purchaser, reconciled with the overall system values selected by the purchaser in step 84. Provision is made for offering to the purchaser on the display station, the system as determined in step 86. A routine is provided, step 87, for displaying appropriate alerts to the purchaser in the event that the purchaser selection made in steps 82 and 84 present reconcilement problems in step 85.

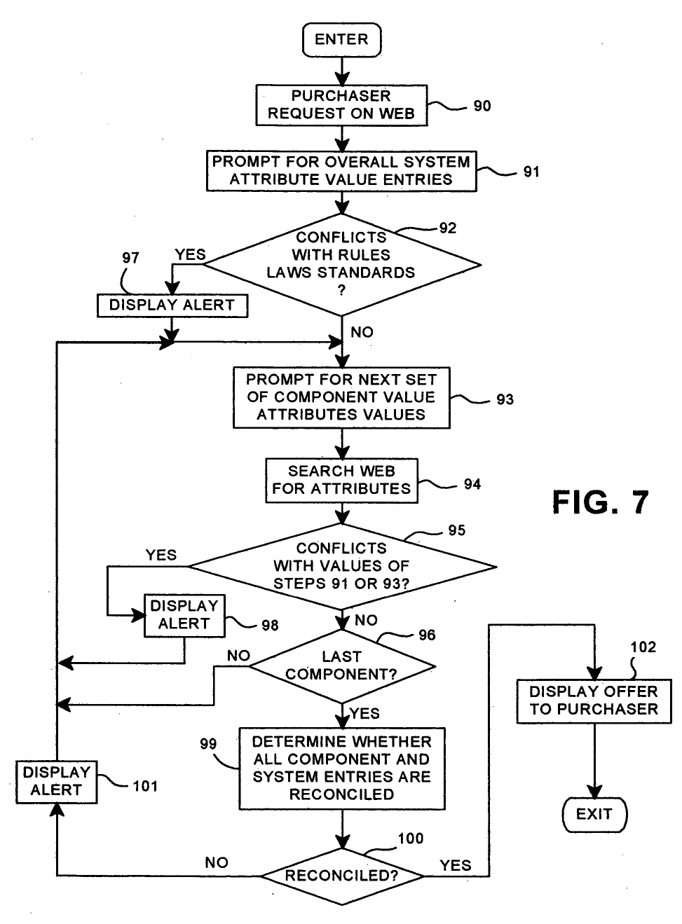

The running of the process set up in FIG. 6 and described in connection with FIGS. 3 through 5 will now be described with respect to the flowchart of FIG. 7. Let us assume that we are in a Web browsing session through the browser. The flowchart represents some steps in a routine that will illustrate the operation of the invention. An initial request is made by a purchaser at a Web station, step 90, for the system of the present invention to offer the purchaser a proposed computer system product. First step, the proposed purchaser is prompted for entries of overall system values as in FIG. 4, step 91. Then, a determination is made as to whether any of these entered attribute values would conflict with any laws, standards or other binding rules, step 92 (these may already be built into the determination system). If Yes, the user is given a display alert as in FIG. 5, step 97. If No, or after step 97, the user is prompted for the next and subsequent sets of component attribute values as in FIG. 3. The search on these attribute values is conducted over the Web as described hereinabove, step 94. Then, for each of the attribute values for each of the components being established, a determination is made, step 95, as to whether there is any conflict between the component attribute values entered in step 93 and the overall computer system attribute values entered in step 91. If Yes, then an appropriate alert is displayed, step 98, and the process is returned to step 93 for the entering of further attribute values. If the determination in step 95 is No conflicts, then a determination may be made as to whether the component being searched on is the last component in the proposed overall computer system, step 96. If No, the process is returned to step 93 for the entering of further attribute values. If the determination from step 96 is Yes, i.e. the last component has been searched on, then a final determination is made, step 99, as to whether all component and overall computer system attribute value conflicts have been reconciled. Then, if the determination in step 100 is No, all have not been reconciled, then an appropriate alert is displayed, step 101, and the process is returned to step 93 for the entering of further attribute values. If the determination in step 100 is Yes, everything has been reconciled and there are no conflicts, then an offer on the overall proposed purchase of the number of computer systems, including components, is made to the purchaser on the display station, step 102, and the session is exited.

Although certain preferred embodiments have been shown and described, it will be understood that many changes and modifications may be made therein without departing from the scope and intent of the appended claims.

1. In a World Wide Web (Web) communication network with user access via a plurality of data processor controlled interactive receiving display stations for displaying received Web documents, transmitted from sources on the Web, a system for offering for sale to a purchaser at a receiving display station a computer system with a plurality of components, each optimized for said purchaser's needs comprising:
means for prompting said purchaser to make a sequence of a plurality of interactive data entries on said display station defining the values of a respective set of attributes selected by said purchaser for each of said components;
means for searching on the Web for sources of components having attributes satisfying said defined values;
means for prompting said purchaser to make a sequence of interactive data entries, on said display station, defining the values of a set of attributes selected by said purchaser for the overall computer system;
means for determining a computer system optimized to purchaser selected values of the attributes of each of said components from said Web sources reconciled with the attribute values selected by the purchaser for the overall computer system; and
means for offering said optimized computer system for sale to said purchaser on said display station.

2. The Web system of claim 1 wherein:
said purchaser is a manufacturer producing a quantity of offered computer systems; and
a quantity of each of said components is to be used in the manufacture of said quantity of said offered computer systems.

3. The Web system of claim 1 wherein at least one of said set of attributes for the overall computer system has values limited by industry standards.

4. The Web system of claim 1 wherein at least one of said set of attributes for the overall computer system has values limited by laws.

5. The Web system of claim 4 wherein said laws limiting said values are environmental laws.

6. The Web system of claim 1 wherein at least one of said set of attributes for the overall computer system has values limited by overall resources available for the overall computer system.

7. The Web system of claim 2 wherein at least one of said set of attributes for at least one of said plurality of components has values limited by a quality of the supplier of said component.

8. In a Web communication network with user access via a plurality of data processor controlled interactive receiving display stations for displaying received Web documents, transmitted from sources on the Web, a method for offering for sale, to a purchaser at a receiving display station, a computer system with a plurality of components, each optimized for said purchaser's needs, comprising the steps of:
prompting said purchaser to make a sequence of a plurality of interactive data entries on said display station defining the values of a respective set of attributes selected by said purchaser for each of said components;
searching on the Web for sources of components having attributes satisfying said defined values;
prompting said purchaser to make a sequence of interactive data entries on said display station, defining the values of a set of attributes selected by said purchaser for the overall computer system;
determining a computer system optimized to purchaser selected values of the attributes of each of said components from said Web sources reconciled with the attribute values selected by the purchaser for the overall computer system; and
offering said optimized computer system for sale to said purchaser on said display station.

9. The Web method of claim 8 wherein:
said purchaser is a manufacturer producing a quantity of offered computer systems; and
a quantity of each of said components is to be used in the manufacture of said quantity of said offered computer systems.

10. The Web method of claim 8 wherein at least one of said set of attributes for the overall computer system has values limited by industry standards.

11. The Web method of claim 8 wherein at least one of said set of attributes for the overall computer system has values limited by laws.

12. The Web method of claim 11 wherein said laws limiting said values are environmental laws.

13. The Web method of claim 8 wherein at least one of said set of attributes for the overall computer system has values limited by overall resources available for the overall computer system.

14. The Web method of claim 8 further including the step of displaying an alert to said purchaser when attribute values selected by said purchaser for components are not reconcilable with attribute values selected by said purchaser for the overall computer system.

15. The Web method of claim 9 wherein at least one of said set of attributes for at least one of said plurality of components has values limited by a quality of the supplier of said component.

16. A computer program having code recorded on a computer readable medium for offering for sale a computer system with a plurality of components, each optimized for a purchaser's needs in a Web communication network with user access via a plurality of data processor controlled interactive receiving display stations for displaying received Web documents, transmitted from sources on the Web, said computer program comprising:
means for prompting said purchaser to make a sequence of a plurality of interactive data entries on said display station defining the values of a respective set of attributes selected by said purchaser for each of said components;
means for searching on the Web for sources of components having attributes satisfying said defined values;
means for prompting said purchaser to make a sequence of interactive data entries on said display station, defining the values of a set of attributes selected by said purchaser for the overall computer system;
means for determining a computer system optimized to purchaser selected values of the attributes of each of said components from said Web sources reconciled with the attribute values selected by the purchaser for the overall computer system; and
means for offering said optimized computer system for sale to said purchaser on said display station.

17. The computer program of claim 16 wherein:
said purchaser is a manufacturer producing a quantity of offered computer systems; and
a quantity of each of said components is to be used in the manufacture of said quantity of said offered computer systems.

18. The computer program of claim 16 wherein at least one of said set of attributes for the overall computer system has values limited by industry standards.

19. The computer program of claim 16 wherein at least one of said set of attributes for the overall computer system has values limited by laws.

20. The computer program of claim 16 wherein at least one of said set of attributes for the overall computer system has values limited by overall resources available for the overall computer system.

21. The computer program of claim 16 wherein at least one of said set of attributes for at least one of said plurality of components has values limited by a quality of the supplier of said component.

22. The computer program of claim 16 further including means for displaying an alert to said purchaser when attribute values selected by said purchaser for components are not reconcilable with attribute values selected by said purchaser for the overall computer system.
